(19) United States
(12) Patent Application Publication
(10) Pub. No.: US 2002/0185905 A1
(43) Pub. Date: Dec. 12, 2002

(54) Cushions and foam material for use in aircraft seats, and associated methods of manufacture

(76) Inventor: Jorge A. Cassinelli, Monroe Center, IL (US)

Correspondence Address: KEITH FRANTZ, 401 WEST STATE STREET, SUITE 200, ROCKFORD, IL, 61101

(21) Appl. No.: 09/955,861

(22) Filed: Sep. 18, 2001

Related U.S. Application Data
(60) Provisional application No. 60/233,407, filed on Sep. 18, 2000.

(51) Int. Cl. B60N 2/44

(52) U.S. Cl. 297/440.22; 297/452.48

(57) ABSTRACT

Cushions for aircraft seats are made with fire-resistant flotation foam laminate comprising alternating layers of soft open-cell foam and closed-cell flotation foam.

Cross-references to related applications: This application claims priority to U.S. Provisional Patent Application S/N 60/233,407, filed Sep. 18, 2000.

Reference to microfiche appendix: not applicable.

Statement Regarding Federally Sponsored Research or Development: not applicable.

### BACKGROUND OF THE INVENTION

1. Field of Invention

The present invention relates generally to the seats of the type suitable for use in aircraft.

More particularly, the invention relates to cushions and cushion blocks of a composite, laminated foam structure suitable for use in aircraft seats; and associated methods of manufacture.

2. Description of Prior Art

As illustrated in FIG. 1, showing a conventional aircraft seat 10 prior to installation of its outer covering such as fabric of leather, aircraft seats are conventionally manufactured from pieces of multi-shaped or contoured foam that are glued together into the desired configuration. The sizes, materials and location of these pieces of foam are selected to meet several design and performance requirements.

In particular, seats in commercial and private aircraft are designed to meet certain FAA fire retardant requirements. In those instances where the seats are not equipped with life preservers, either or both of the seat or back cushions are also designed to meet certain flotation requirements, and to be manually removable (i.e., without the need for tools) from the seat frame for use as a flotation device. Of course, it is also desired that the seats be relatively soft for passenger comfort during long flights.

The flotation requirement is conventionally met by including sufficient quantity of “closed-cell” flotation foam such as manufactured from polyethylene in the seat or back cushion. This material is typically relatively rigid, and must therefore be positioned away from the exposed seating areas of the cushion for purposes of passenger comfort.

The fire retardant requirement is conventionally met with a fire resistant barrier such as a layer of Kevlar fabric or other fire resistant material.

In view of these requirements, aircraft seat cushions are conventionally constructed with (i) a contoured block of flexible, relatively soft, “open-cell” polyurethane foam in the center portion of the cushion to provide a level of seating comfort, (ii) a contoured block or wedge of closed-cell flotation foam attached to the bottom of the softer polyurethane block, and optionally in other locations outside the seating area such as the front or sides of the cushion as needed to meet the flotation requirements, and (iii) a layer of Kevlar fabric encasing the entire seat cushion. The seat back cushions are similarly constructed to meet comfort, fire retardant and flotation requirements.

Simplified views of an aircraft seat 20 are shown in FIGS. 2-4 to illustrate the basic nature of conventional aircraft seat construction. In this instance, the seat cushion 24 includes an upper open-cell polyurethane block 34 and a lower flotation wedge 32, the back cushion 22 includes a front polyurethane block 28 and a back flotation block 30, both cushions 22, 24 are wrapped in Kevlar fabric 26, and hook and loop strips 36 are provided on the fabric covering of the cushion for removable attachment to complimentary strips secured to the seat frame. Additional information on conventional construction of aircraft seats is discussed and disclosed in U.S. Pat. Nos. 4,031,579; 5,283,918; 5,632,053; 5,650,448; 5,719,199 and 5,836,547.

Unfortunately, there are several drawbacks and deficiencies associated with such conventional prior seat construction. Among these: (i) there is a cost associated with the need to provide the separate fire barrier over the cushion (e.g., Kevlar wrap); and (ii) due to limited space constraints typical of many aircraft installations, the soft upper open-cell foam seating block (e.g., block 34 shown in FIG. 2) tends to “bottom out” against the rigid polyethylene flotation wedge (e.g., item 32 in FIG. 2), resulting in seating discomfort particularly on longer flights and/or with larger persons.

In recent years, fire resistant, flexible open-cell polyurethane foams have become available. Briefly, these foams use expandable graphite to achieve a desired level of flame resistance.

Use of such flame resistant polyurethane foam eliminates the need to cover this portion of the seat cushion with a flame barrier. However, the closed-cell flotation wedge must still be wrapped in Kevlar with conventional seat construction techniques.

Still more recently, flame resistant, closed-cell polyethylene foam has become known, such as disclosed in Wallace et al. U.S. Pat. No. 5,650,448. According to the disclosure of the Wallace, use of such material eliminates the need for the Kevlar warp around the flotation device, and permits the use of a softer closed-cell foam for improved design freedom such as to reduce the bottoming-out effect that may be associated with use of the conventional hard flotation wedge.

Although these improvements in foam materials have eliminated the need to encase the seat cushions in fire resistant Kevlar fabric, and the cost associated therewith, problems remain associated with use of such enhanced foams in conventionally constructed seats. In particular, there is uncertainty as to the ability of the newer fire resistant closed-cell foams to eliminate the discomfort that can be associated with the flotation wedge; and since the use of the fire resistant open-cell polyurethane and closed-cell polyethylene foams are protected by patents, they may not be generally available for use for a period of time. Thus, there is a need for suitable alternate materials and methods of seat construction that are adapted to achieve the required fire resistance as well as to reduce the possible discomfort associated with the conventional flotation wedge;

In addition, contouring of the polyurethane seat block and the flotation wedge can result in a substantial waste in materials as a result, the cost of the material necessary to make a cushion can be far greater than the cost of the material that ends up in the cushion. In some instances, the cost of this waste material approaches and can exceed the cost of the material in the remaining contoured part, such as cushions where the lower portion of the softer block is carved-out and subsequently filled by the flotation wedge, such as illustrated in the common conventional construction technique shown in FIG. 8.

None of the above-discussed or other known prior methods, materials or techniques currently used in the manufacture of aircraft seats address the cost of the waste associated with contouring seat cushion pieces. This unnecessary cost becomes even more substantial as the use of the above-mentioned, more expensive, fire resistant foams increases.

Accordingly, there is a need for improved aircraft seat construction, and improved materials and techniques for the construction of aircraft seats that reduces the potential seating discomfort associated with conventional flotation wedges, and that reduces the waste foam product associated with the contouring of the foam pieces in conventional aircraft seat construction, while providing the desired flotation and fire retardant characteristics. In addition, there is an ever present need for improvements that reduce other costs associated with the manufacture of aircraft seat cushions.

### SUMMARY OF THE INVENTION

A general aim of the invention is to provide new and improved construction of, and materials and techniques for fabricating cushions for use aircraft seats.

Another aim of the invention is to reduce the waste foam product associated with the conventional materials and techniques used for constructing aircraft seats, as well as reduce the other costs associated with the manufacture of aircraft seats.

These and other objectives and advantages of the invention will become more apparent from the following detailed description when taken in conjunction with the accompanying drawings.

Briefly, the present invention contemplates a cushion comprising layers of soft open-cell foam and closed-cell flotation foam laminated into a composite foam structure that provides desired flotation and fire retardant characteristics suitable for use in aircraft seats.

The invention also contemplates a material comprising layers of soft open-cell foam and closed-cell flotation foam laminated into a composite foam portion that provides the desired flotation and fire retardant characteristics, and is suitable for cutting into cushion blocks for use in aircraft seats.

The invention also resides in the associated methods of manufacturing the composite foam material, and in the manufacture of seat cushions and seats therefrom.

As discussed in further detail below, the composite foam material and cushions made therefrom (i) exhibit improved resistance to bottom-out with a passenger in the seat, (ii) provide improved buoyancy for a given thickness of soft foam and flotation foam, and (iii) in certain embodiments, eliminate the need to cover the flotation foam with a fire resistant Kevlar covering, as well as (iv) reducing waste foam and the cost of fabricating the cushions.

### BRIEF DESCRIPTION OF THE DRAWINGS

FIG. 1 is a perspective view of a conventional aircraft seat prior to installation of its outer cover.

FIG. 1A is a perspective view similar to FIG. 1 of an aircraft seat incorporating the unique aspects of the present invention, but shown in position with a seat frame.

FIG. 2 is a perspective view of a simplified conventional aircraft seat.

FIG. 3 is a back view of the back cushion of FIG. 2.

FIG. 4 is a bottom view of the seat cushion of FIG. 2.

FIG. 5 is a perspective view of a composite, laminate foam sheet portion incorporating the unique aspects of the present invention.

FIG. 6 is a perspective view of a foam portion similar to the portion shown in FIG. 5 but made with conventional aircraft seat construction techniques.

FIG. 7 is a perspective view illustrative of the lamination process of the composite foam portion shown in FIG. 5.

FIG. 8 is an exploded perspective view of a conventionally constructed aircraft seat cushion.

FIG. 9 is a view similar to FIG. 8 but showing a cushion manufactured in accordance with the present invention.

FIG. 10 is a perspective view of an alternate seat ion in accordance with the invention.

FIG. 11 is a bottom view of the cushion of FIG. 10.

FIG. 12 is a perspective view of a seat back cushion accordance with the invention.

FIG. 13 is a back view of the cushion of FIG. 12.

Reference numerals shown in the drawings correspond to following items:

| | |
|---|---|
| 10 | conventional aircraft seat |
| 10a | aircraft seat |
| 12 | frame |
| 14 | seat cushion |
| 14′ | alternate seat cushion |
| 16 | back cushion |
| 18 | fabric covering |
| 20 | simplified representation of conventional aircraft seat |
| 22 | seat back of aircraft seat 20 |
| 24 | seat cushion of aircraft seat 20 |
| 26 | fire-resistant Kevlar fabric cover |
| 28 | polyurethane block of seat back 22 |
| 30 | flotation foam block of seat back 22 |
| 32 | flotation foam block of seat cushion 24 |
| 34 | soft block of seat cushion 24 |
| 36 | strips of one-half of hook and loop fastener secured to |
| | fabric covering of cushions |
| 40 | laminate foam sheet portion-cushion block |
| 42 | soft foam sheets of cushion block 40 |
| 44 | flotation foam sheets of cushion block 40 |
| 50 | conventional cushion block |
| 52 | soft foam layer of block 50 |
| 54 | flotation foam layer of block 50 |
| 60 | conventional seat cushion |
| 62 | soft foam block of cushion 60 |
| 64 | flotation wedge of cushion 60 |

While the invention is susceptible of various modifications and alternative constructions, a certain illustrated embodiment has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DETAILED DESCRIPTION OF THE INVENTION

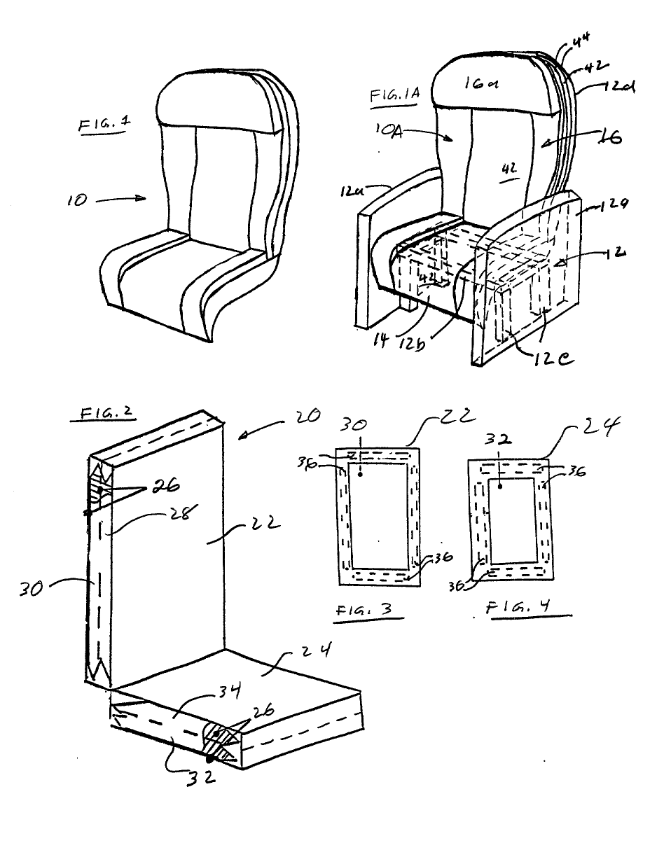

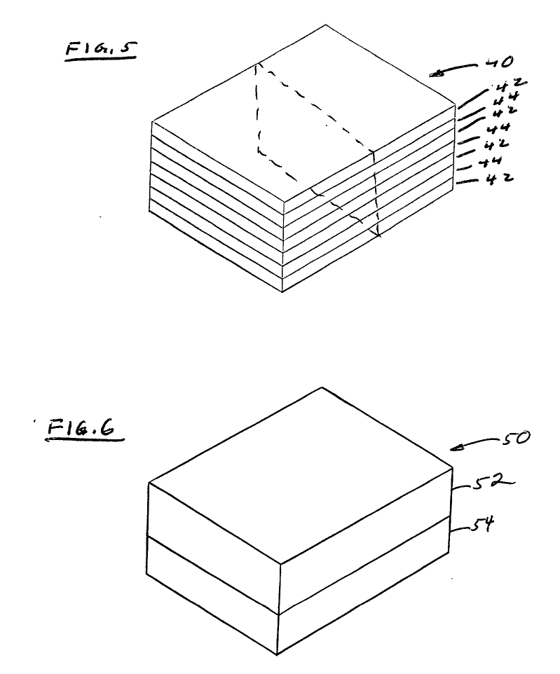

For purposes of illustration, the present invention is shown in the drawings in connection with an aircraft seat 10A (FIG. 1A) adapted to meet applicable FAA fire retardant and flotation requirements.

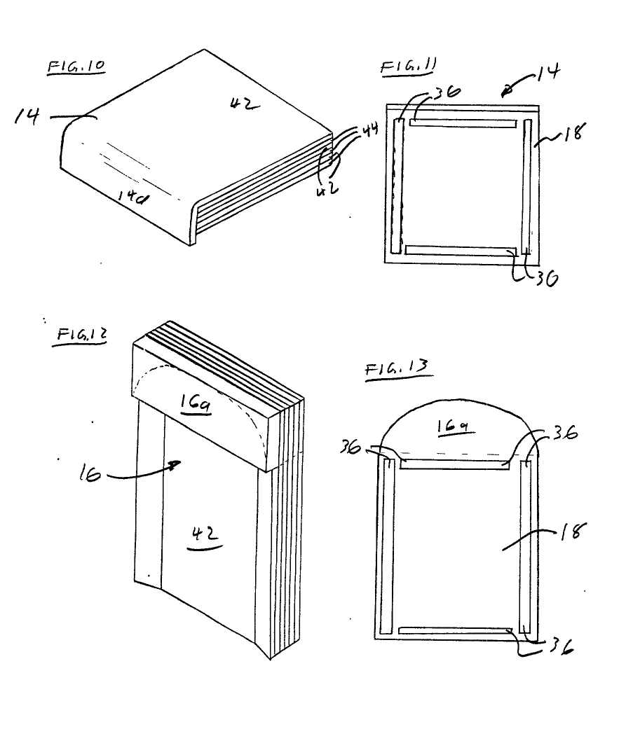

Briefly, the aircraft seat 10A includes a frame generally indicated as reference numeral 12, shown including side armrest frame members 12a, horizontal frame members 12b supported by vertical frame members 12c, and a generally vertical frame structure 12d extending across the back of the seat; a seat cushion 14; and a seat back 16. In this instance, both the seat and back cushion are releasably connected to the horizontal and vertical frame members, respectively, with conventional hook and loop fasteners (see e.g., FIGS. 11 and 13) such as VELCRO brand hook and loop fasteners, to function as flotation devices when manually removed therefrom. In alternate embodiments, only one or neither of the seat and back cushions are releasably connected to the seat frame. In use, the seat 10A is also covered with a suitable material (not shown) such as fabric or leather.

In accordance with one aspect of the invention, the seat cushion 14 and the seat back 16 are constructed from alternating layers of (i) relatively soft, open-cell foam sheet portions 42 such as polyurethane or other known soft materials suitable for use in the cushions of aircraft seats, and (ii) closed-cell flotation foam sheet portions 44 such polyethylene or other known materials of a type suitable for use in flotation devices of aircraft seats, with the alternating layers of soft foam and flotation foam extending generally normal or perpendicular to the direction of passenger weight applied thereto with a passenger seated on the seat cushion and resting against the seat back. In particular, the alternating layers of soft foam and flotation foam extend generally horizontal in the seat cushion (see e.g., FIGS. 9 and 10), and generally vertical in the seat back when in its upright vertical position.

In carrying out this aspect of the invention, the alternating layers 42, 44 include at least a first outer layer of soft foam 42 presented upwardly in the seat cushion and forwardly in the seat back for passenger comfort when seated therein, followed by the alternating layers of soft foam and flotation foam. As constructed in the cushions 14 and 16, the alternating layers of foam 42 and 44 are tightly glued or laminated together, with the open-cell and closed-cell foam sheet portions being of approximately the same thickness.

The seat cushion 14 and back cushion 16 are further provided outer contoured layers including a front leg-rest 14a and a head-rest 16a, respectively, of the soft foam material. As shown in FIGS. 9 and 10, the leg-rest portion may be formed separately from or integrally with the upwardly presented layer of soft foam of the seat cushion.

Simplified representations of the seat cushion 14 and seat back 16 in accordance with the invention are shown in FIGS. 9-13. In particular, perspective views of alternate embodiment seat cushions 14′ and 14 are shown in FIGS. 9 and 10, respectively, without the outer fabric cover, the seat back is shown in FIG. 12 prior to contouring the head-rest area as indicated in dashed lines and without the fabric cover, and the seat cushion of FIG. 10 and seat back of FIG. 12 and seat back are shown finished with a fabric covering 18 and with strips 36 of one-half of hook and loop fasteners connected thereto.

In accordance with another aspect of the invention, seat cushion and seat back flotation devices such as cushions 14 and 16 are formed from a composite, laminate foam sheet portion 40 shown in FIG. 5.

The foam sheet portion 40 is formed with alternating layers of (i) relatively soft, open-cell foam sheet portions 42 such as polyurethane or other known soft materials suitable for use in the cushions of aircraft seats, and (ii) closed-cell flotation foam sheet portions 44 such a polyethylene or other known materials of a type suitable for use in flotation devices of aircraft seats. The composite foam sheet is formed by tightly gluing or laminating the alternating foam material sheet portions 42 and 44, with the open-cell and closed-cell foam sheet portions being of approximately the same thickness.

The seat cushion and seat backs are then fabricated from the sheet portion 40 by cutting the sheet portion transversely across the alternating layers of foam into cushion blocks of suitable size (such as indicated in dashed lines in FIG. 5), optionally contouring the cushion blocks as desired, and gluing one or more contoured soft foam finishing portions to each of the cushion blocks. The cushions are then finished with a suitable covering such as fabric or leather. As indicated above, the cushions are constructed with the layers of the cushion block running perpendicular to the direction of passenger weight applied thereto with a passenger seated on the seat cushion and resting against the seat back. As also indicated above, the finished cushions are provided with suitable means for removably connecting to the seat frame.

In certain embodiments, the composite sheet 40 is preferably formed with at least one outer layer of the open-cell foam 42, and the cushion block cut therefrom is oriented with this outer soft foam layer presented outwardly for seating comfort of the passenger. This eliminates the need to provide a separate outer contoured soft foam piece over the entire cushion.

With the foregoing arrangement, the composite foam material is suitable for use in aircraft seat cushions:

providing seating comfort without the danger of the “bottoming-out” effect of conventionally constructed seat cushions; and

providing the necessary flotation characteristics without the need for separate flotation wedges of conventionally constructed seat cushions.

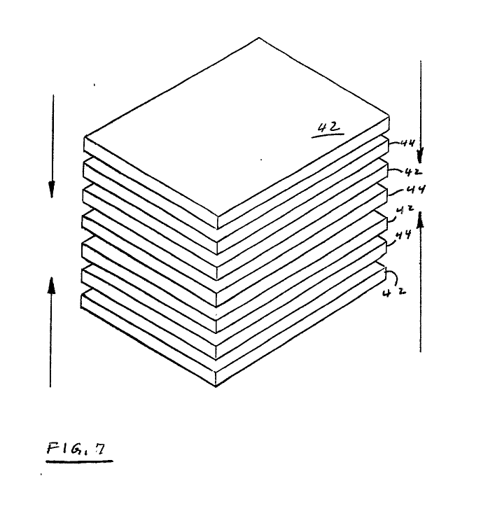

In a comparison of the composite foam portion 40 (FIG. 5) with a similarly sized and shaped, conventionally constructed foam block 50 (FIG. 6) comprising a layer of open-cell foam 52 and a single wedge or layer of closed-cell flotation foam 54, it has been found that, for equal total thickness of the closed-cell foam portions 42 and 52, the composite block 40 will exhibit improved buoyancy as compared with the block 50.

This improved buoyancy is due to the fact that:

the open-cell foam sheet portion 52 of the block 50 takes on water when submerged, and contributes little, if any, to the buoyancy of the block 50;

whereas, the inside layers of open-cell foam 42 of the block 40, i.e., those layers surrounded on both sides by a closed-cell layer 44, do not take-on water despite the open-cell nature of the foam.

In other words, open-cell material 52 in prior conventionally constructed blocks 50 simply soaks up water when submerged.

On the other hand, the open-cell sheets 42 that are encased in the closed-cell sheets in the composite block 40 are unable to take-on water because

only the thin sides of the sheet portions 42 are exposed when submerged in water, and

they are exposed to substantially equal, hydrostatic pressure.

As a result, the air in these sandwiched layers 42 of open-cell material is trapped when the block is submerged, enhancing the buoyancy of the composite block as compared with the buoyancy of the closed-cell sheet portions alone and with the conventionally constructed block 50.

Thus, cushion blocks and cushions in accordance with the invention includes at least one layer of soft foam sandwiched between and to layers of the flotation foam to achieve this enhanced buoyancy.

It has also been found that, for equal total thickness of the open-cell and closed-cell foams, the composite block 40 exhibits improved resistance to “bottoming-out” under a given load condition.

In addition, with the improved buoyancy of the composite block 40, less closed-cell material is needed to meet a given flotation requirement. Thus, an additional thickness of the softer open-cell foam may be used for a given overall block thickness, further contributing to the composite block enhanced resistance to bottoming-out.

In certain preferred embodiments, the open-cell foam sheet portions 42 are formed from a known fire resistant open-cell foam material such as material sold under the trade name DAX by North Carolina Foam Industries of Mount Airy, N.C. In these instances, it is also preferred that both outer layers of the composite sheet 40 are formed with the open-cell fire resistant foam material.

With such the fire resistant open-cell foam substantially surrounding the closed-cell flotation foam, is has been found that the block 40 will often meet the necessary fire resistance characteristics for aircraft seating without the need to either encase the entire composite sheet portion in Kevlar, or to use the more expensive known fire resistant closed-cell material.

In carrying out another aspect of the invention, mass production of the composite sheet foam material 40, and its subsequent use in the manufacture of aircraft seats, provides several advantages over prior conventional manufacturing techniques.

Production of the composite sheet foam 40 is accomplished by spraying or otherwise applying a coating of suitable glue between the layers and compressing the layers as generally indicated by the arrows in FIG. 7. This production is preferably carried out with either press machinery for batch-type processing, or with a roller-conveyer arrangement adapted to compress the alternating layers of material in a substantially continuous manufacturing process.

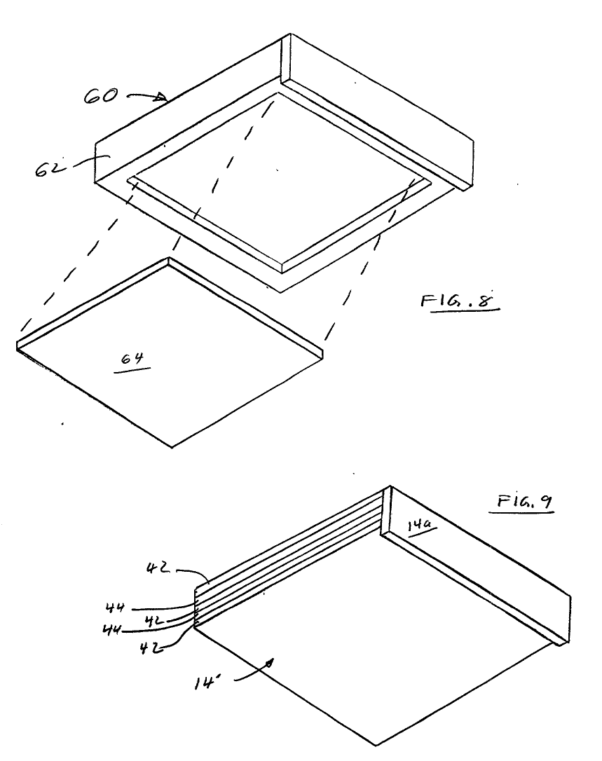

For illustrative and comparison purposes, implementation of the composite, laminate foam sheet portion 40 in a simplified configuration aircraft seat cushion is shown in FIG. 9, and a similarly configured, conventionally constructed seat cushion 60 provided with a soft foam block 62 and a flotation wedge 64 is shown in FIG. 8.

By such comparison, it will be evident that use of the composite foam material 40 reduces the seat cushion manufacturing cost and time by eliminating the need to

(i) cut the flotation block,

(ii) form the cut-out in the open-cell foam for the flotation block, and

(iii) install the flotation block in the cut-out either temporarily with hook and loop fasteners or permanently with glue, both of which are manual operations.

The manufacture of the composite sheet foam 40 will entail some cost not present in the conventional construction of the cushions. However, since this process is, in preferred embodiments, at least substantially automated, it will also be substantially less expensive that the manual cutting, assembly and gluing procedures used for conventionally constructed seat cushions.

As previously discussed, and is evident from FIG. 9, conventional seat construction techniques result is substantial material waste. In instances where the seat cushions are contoured such as shown in FIG. 1, this waste and cost can become substantial.

Advantageously, by providing composite/laminated open-cell/closed-cell foam sheets of the desired thickness, the composite foam material 40 is manufactured with very little scrap.

In instances of a contoured seat, there may be some waste of the composite foam material 40 when the composite foam block is contoured. Nevertheless, such waste will be less than the waste associated with conventional construction techniques because:

the only material lost in the contouring of the composite foam material is due solely to the seat contour, and

no material will be lost in order to meet flotation requirements (compare e.g., the lost material of the cushion shown in FIG. 8 to make room for the flotation wedge).

Alternately, the cushion may be constructed with a generally rectangular composite foam block as shown, connected to an outer foam shell contoured from suitable open-cell (or close-cell) foam configured in a manner to minimize overall waste resulting from the contouring step (see e.g., the cushion shown in FIG. 10).

Additional cost advantages will also be achieved with the composite foam material of the present invention.

Since the composite sheet material 40 can be manufactured with any number of desired layers, the thickness of the seat cushion will not drive the thickness of raw material that must be purchased or provided for manufacture of the cushion.

With the conventionally constructed seat cushions, the thickness of the raw material that is purchased and supplied for the manufacture of the cushions is established, in part, by the thickness of the cushion or the pieces glued together.

On the other hand, the thickness of the open-cell foam and closed-cell raw foam sheet material that is purchased and supplied for manufacture of the seat cushion is, to a great extent, independent of the seat cushion thickness. In particular, the open-cell and closed-cell foam can be purchased in sheets of constant thickness, and then processed into composite sheets of various thickness, for use with different thickness seat cushions, by manufacturing the composite sheet with a varying number of layers. As a result, not only is the cost reduced from the reduction of waste, only one or a reduced number of thickness of the open-cell and closed-cell raw material foam need be stocked to be able to manufacture seat cushions of a variety of thickness, with reduced stocking costs, and economies of purchasing larger quantities of the same sized foam sheets will also be realized.

Still additional cost savings are achievable with the manufacture of the composite foam material 40 in the composite lamination process contemplated herein by using smaller pieces of both the open-cell and closed-cell foam, pieces that might otherwise be scrap such as resulting from conventionally constructed seat cushions.

Accordingly, aircraft seat cushions of the alternating layers of soft foam and flotation foam, and cushion blocks of the composite foam 40, are uniquely adapted to provide necessary flotation and fire resistance requirements of aircraft seat cushions, with improved seating comfort for the passenger, and the manufacture of composite foam material and the manufacture of aircraft seating therefrom results in reduction of waste and substantial savings over prior conventionally constructed seat and back cushions.

I claim:

1. A flotation device suitable for alternate use as a seat cushion, said device comprising:
first and second layers of relatively soft, open-cell foam;
a first layer of flotation foam bonded to and between said first and second layers of open-cell foam; and
a second layer of flotation foam bonded to one of said layers of open-cell foam oppositely of said first layer of flotation foam;
said layers of foam being of approximately equal thickness and extending substantially parallel to one another.

2. The flotation device of claim 1 further comprising a third layer of relatively soft, open-cell foam bonded to said second layer of flotation foam oppositely of said one layer of open-cell foam, and in which said layers of open-cell foam are of a fire-resistant composition such that the layers of flotation foam are substantially protected from open flame.

3. The flotation device of claim 1 further comprising an encasing layer of fire-resistant Kevlar fabric.

4. The flotation device of claim 1 in which said open-cell foam is a urethane-based foam, and said flotation foam is a ethylene-based foam.

5. A seat cushion suitable for use in an aircraft seat connected to a seat frame, the seat cushion comprising:
a plurality of substantially horizontal spaced layers of relatively soft, open-cell foam;
a plurality of substantially horizontal spaced layers of closed-cell flotation foam bonded to the layers of open-cell foam and alternating therewith such that the internal layers of open-cell foam are rendered substantially water non-absorbent; and
means for manually releasably connecting the seat cushion to the frame.

6. The seat cushion of claim 5 in which said open-cell foam is of fire-resistant composition such that the internal layers of flotation foam are protected from open fire.

7. The seat cushion of claim 5 further comprising a contoured layer of bonded open-cell foam for defining an outer seat contour.

8. An aircraft seat comprising:
a frame;
a substantially horizontal seat cushion connected to the frame;
a substantially vertical seat back connected to the frame; and
means for manually releasing at lease one of said seat cushion and said seat back from said frame;
said one of said seat cushion and said seat back including:
(i) first and second layers of relatively soft, open-cell foam,
(ii) a first layer of flotation foam bonded to and between said first and second layers of open-cell foam, and
(iii) a second layer of flotation foam bonded to said second layer of open-cell foam oppositely of said first layer of flotation foam;
said layers of foam extending generally perpendicular to the direction of passenger weight applied thereto with a passenger seated on the seat cushion and resting against the seat back.

9. The aircraft seat of claim 8 further comprising a third layer of relatively soft, open-cell foam bonded to said second layer of flotation foam oppositely of said second layer of open-cell foam, and in which said layers of open-cell foam are of a fire-resistant composition such that the layers of flotation foam are substantially protected from open flame.

10. The aircraft seat of claim 8 further comprising a contoured layer of bonded open-cell foam for defining an outer seat contour.

11. The aircraft seat of claim 10 in which said contoured layer includes one of a leg-rest and a head rest associated with said one of said seat cushion and said seat back, respectively.

12. A method of manufacture of an aircraft seat having a seat cushion and a seat back connected to a seat frame, the method comprising the steps of:
providing alternating bonded layers of (i) relatively soft open-cell foam and (ii) flotation foam;
transverse cutting the bonded layers of foam into a cushion block;
securing a foam finishing portion to the cushion block;
contouring the foam finishing piece; and
releasably connecting the cushion block and the contoured portion to the seat frame for defining one of the seat cushion and the seat back, with the layers of the cushion block running perpendicular to the direction of passenger weight applied thereto with a passenger seated on the seat cushion and resting against the seat back.

13. The method of claim 12 in which said layers of open-cell foam is of a fire-resistant composition such that the layers of flotation foam are protected from open flame.

14. The method of claim 12 further comprising the step of contouring the cushion block.
